(19) United States
(12) Patent Application Publication
(10) Pub. No.: US 2025/0042261 A1
(43) Pub. Date: Feb. 6, 2025

(54) EMERGENCY OPERATION OF AN LV LOAD OF AN ELECTRIC VEHICLE

(71) Applicant: AUDI AG, Ingolstadt (DE)

(72) Inventors: Christian GLÜCK, Ingolstadt (DE); Thomas HACKNER, Greding (DE); Markus NIEDERMEIER, Wolnzach (DE)

(21) Appl. No.: 18/789,368

(22) Filed: Jul. 30, 2024

(30) Foreign Application Priority Data
Aug. 3, 2023 (DE) 102023120573.0

(51) Int. Cl. B60L 15/20; B60L 1/00; B60L 3/00; B60L 3/04

(52) U.S. Cl. CPC B60L 15/20; B60L 3/0046; B60L 3/04; B60L 1/00; B60L 2220/14; B60L 2240/12; B60L 2240/547; B60L 2240/642; B60L 2260/24

(57) ABSTRACT

A method for operating a low-voltage (LV) load of an electric vehicle, in which an LV load of an electric vehicle is operated with a provided operating voltage, and a drive system for an electric vehicle, and electric vehicle.

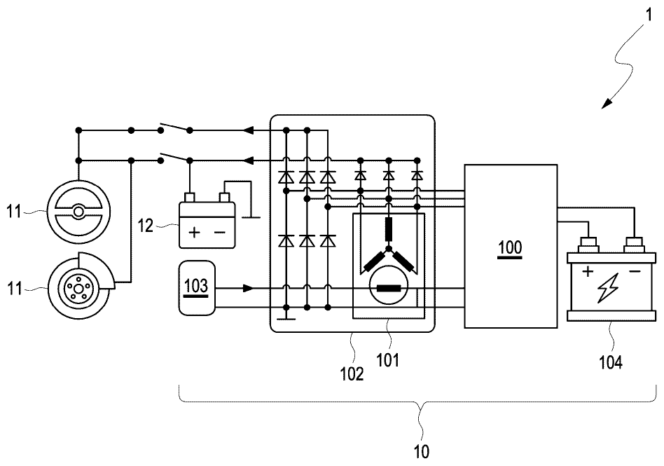

### BACKGROUND

### Technical Field

The disclosure relates to a method for operating a low-voltage (LV) load of an electric vehicle, wherein an LV load of an electric vehicle is operated with a provided operating voltage. The disclosure further relates to a drive system for an electric vehicle and an electric vehicle.

### Description of the Related Art

An electric vehicle usually comprises a high-voltage (HV) battery that provides an operating voltage for a drive system of the electric vehicle. The operating voltage provided by the HV battery, a direct voltage, can be several hundred volts. The term “battery” is generally understood to mean a storage device for electrical energy. The electric vehicle is preferably designed as a Battery Electric Vehicle, BEV.

An HV power electronics in the electric vehicle generate a multi-phase alternating voltage from the operating voltage provided, which drives a traction motor of the electric vehicle. The HV power electronics and the traction motor are HV loads installed in the electric vehicle.

Apart from that, the electric vehicle comprises a plurality of LV loads. An electric vehicle DC-DC converter, that is to say a direct current (DC) voltage converter, connected to the HV battery provides an operating voltage for the LV loads, that is to say the LV loads are also operated with electrical energy provided by the HV battery. The operating voltage provided by the DC-DC converter is usually 12 V.

For example, DE 10 2017 114 339 A1 discloses a power supply system for an electric vehicle with an HV battery that can comprise a plurality of separate battery strings. The system also includes a DC-DC converter connected to the HV battery, which DC-DC converter provides an operating voltage for LV loads. The DC-DC converter can be connected directly to each battery string, so that the operating voltage for the LV loads is provided even if an individual battery string fails or HV contacts of the HV battery are de-energized for safety reasons, for example after an accident involving the electric vehicle.

In addition, the electric vehicle can comprise an LV battery, which provides the operating voltage for the LV loads. The operating voltage provided by the LV battery is usually 12 V.

CN 206 954 014 U and CN 108 638 983 A each disclose such a power supply system for an electric vehicle, which comprises an HV battery, an LV battery and a bidirectional DC-DC converter connected to the HV battery and the LV battery. In the event of a failure of the HV battery, an HV load of the electric vehicle can be operated with electrical energy provided by the LV battery.

Likewise, if the HV battery fails, the LV loads can continue to operate with the electrical energy provided by the LV battery.

However, after the failure of the HV battery, either the operating time of the LV loads may be too short or the capacity of the LV battery must be large, which is associated with high costs and a large mass of the electric vehicle.

### BRIEF SUMMARY

The present disclosure provides a method for operating an LV load of an electric vehicle, which allows a long operating time of the LV load in the event of a failure of the HV battery, can be implemented cost-effectively and does not significantly increase a mass of the electric vehicle. Further embodiments of the disclosure provide a drive system for an electric vehicle and an electric vehicle.

An embodiment of the disclosure is a method for operating an LV load of an electric vehicle, wherein an LV load of an electric vehicle is operated with a provided operating voltage. The provided operating voltage is usually 12 V. The electric vehicle generally comprises a plurality of LV loads that are operated with the provided operating voltage.

According to the disclosure, a traction motor of the electric vehicle is operated as an LV generator while the electric vehicle is traveling in an emergency mode, and LV power electronics connected to the traction motor provides the operating voltage for the LV load. The emergency mode ensures that the LV load is operated with electrical energy provided by the traction motor when the electric vehicle is traveling passively, that is to say without a traction torque generated by the electric vehicle. As long as the electric vehicle is traveling passively, operation of the LV load is guaranteed thanks to the operation of the traction motor as an LV generator.

It is emphasized that in emergency mode, an LV battery of the electric vehicle is in principle not required, since the traction motor continuously provides the electrical energy for the LV load while the electric vehicle is traveling passively.

In one embodiment, an HV battery of the electric vehicle provides an operating voltage for the traction motor of the electric vehicle, and, while traveling in a normal operating mode, the traction motor is operated as a drive machine with the provided operating voltage, and the traction motor is switched from the normal operating mode to the emergency operating mode if the HV battery fails during travel. If the HV battery fails, for example as a result of a technical failure or an accident of the electric vehicle, normal operation of the traction motor cannot be maintained and switching to the emergency operating mode can easily occur. In the normal operating mode, a DC-DC converter connected to the HV battery and the LV load can provide the operating voltage for the LV load.

Preferably, the LV load is disconnected from the HV battery and connected to the LV power electronics if the HV battery fails while traveling. In other words, the LV load is not connected to the HV battery and the LV power electronics at the same time.

In the emergency operating mode, an LV battery of the electric vehicle advantageously provides the operating voltage for the LV load when the operating voltage provided by the traction motor in the emergency operating mode drops. The LV battery stores electrical energy as a buffer storage and provides the stored electrical energy for the LV load in order to compensate for fluctuations in the operating voltage provided by the traction motor. In this way, the operating voltage of the LV load is stabilized.

Furthermore, a driving speed of the electric vehicle is advantageously limited in emergency operating mode. Thanks to the limited driving speed, the LV load is protected from overvoltage.

The travel of the electric vehicle can comprise coasting, rolling downhill of the electric vehicle or being towed. Said coasting, rolling downhill and being towed are each passive travel of the electric vehicle during which maneuverability of the electric vehicle is permanently maintained thanks to the emergency operating mode.

Another embodiment of the disclosure is a drive system for an electric vehicle, comprising HV power electronics and a traction motor connected to the HV power electronics. Such drive systems are widespread, so that the disclosure can be used in a wide variety of ways.

According to the disclosure, the drive system comprises LV power electronics connected to the traction motor and the HV power electronics. The LV power electronics is designed to provide the operating voltage for the LV load in the emergency operating mode. The power electronics can comprise a plurality of diodes and can be added to an existing drive system. The power electronics is a low cost and low mass power electronics.

The low-voltage power electronics can be designed separately from the HV power electronics or integrated into the HV power electronics.

The traction motor is preferably designed as a separately excited synchronous motor, FSM. The separately excited synchronous motor comprises an electromagnet which generates a magnetic field for a rotor of the synchronous motor when an excitation current flows through it. Thanks to the electromagnet, the separately excited synchronous motor is readily suitable for methods according to the disclosure. A current sensor connected to the electromagnet can provide the excitation current for the electromagnet.

A third embodiment of the disclosure is an electric vehicle comprising a HV battery, a drive system and an LV load.

According to the disclosure, the electric vehicle comprises LV power electronics, functionally connected to the LV load, of a drive system connected to the HV battery according to one embodiment of the disclosure. The electric vehicle naturally also comprises the drive system. In the event of a failure of the HV battery while the electric vehicle is traveling, the drive system enables an emergency operating mode of the traction motor, which supports operation of the LV load without the involvement of the HV battery.

Preferably, the LV load is designed as a by-wire steering system of the electric vehicle and/or a by-wire brake of the electric vehicle. If the traction motor supplies the by-wire steering system or the by-wire brake with the operating voltage in the emergency operating mode, the electric vehicle remains maneuverable even if the HV battery fails. For example, a steering system compatible with the ECE R-79 regulation can be provided in this way.

A significant advantage of the method according to the disclosure is that it enables a long operating time of the LV load in the event of a failure of the HV battery, is cost-effective to implement and does not significantly increase a mass of the electric vehicle.

### BRIEF DESCRIPTION OF THE SEVERAL VIEWS OF THE DRAWINGS

The disclosure is shown schematically in the drawings using an embodiment and is further described with reference to the drawings.

The FIGURE shows a circuit diagram of a section of an electric vehicle according to an embodiment of the disclosure.

### DETAILED DESCRIPTION

The FIGURE shows a circuit diagram of a section of an electric vehicle 1 according to an embodiment of the disclosure. Electric vehicle 1 comprises an LV load 11 or several LV loads 11. LV load 11 can be designed as a by-wire steering system of electric vehicle 1 or as a by-wire brake of electric vehicle 1. Electric vehicle 1 can also comprise an LV battery 12 connected to LV load 11.

Electric vehicle 1 further comprises LV power electronics 102 of a drive system 10 according to an embodiment of the disclosure, which is functionally connected to LV load 11. Drive system 10 is suitable for electric vehicle 1, is part of electric vehicle 1 and comprises HV power electronics 100, a traction motor 101 connected to HV power electronics 100, and LV power electronics 102 connected to traction motor 101 and HV power electronics 100. Traction motor 101 can be designed as a separately excited synchronous motor, FSM. Drive system 10 can further comprise a current sensor 103 connected to traction motor 101 and/or an HV battery 104 connected to power electronics unit 100.

The drive system is designed to carry out a method according to an embodiment of the disclosure as follows for operating LV load 11 of electric vehicle 1.

HV battery 104 of electric vehicle 1 can provide an operating voltage for traction motor 101 of electric vehicle 1, more specifically HV power electronics 100. While traveling in a normal operating mode, traction motor 101 can be operated as a drive machine with the provided operating voltage. Traction motor 101 can be switched from the normal operating mode to an emergency operating mode if the HV battery 104 fails during travel.

Traction motor 101 of electric vehicle 1 is operated as an LV generator during the travel of electric vehicle 1 in the emergency mode. Travel of electric vehicle 1 comprises, for example, electric vehicle 1 coasting, electric vehicle 1 rolling downhill or electric vehicle 1 being towed.

LV power electronics 102 connected to traction motor 101 provides an operating voltage for an LV load 11 of electric vehicle 1. LV load 11 is operated in the emergency operating mode with the provided operating voltage.

Preferably, LV load 11 is disconnected from HV battery 104 and connected to LV power electronics 102 if HV battery 104 fails during travel.

In addition, in the emergency operating mode, an LV battery 12 of electric vehicle 1 can provide the operating voltage for LV load 11 if the operating voltage provided by traction motor 101 in the emergency operating mode drops.

Ideally, the driving speed of the electric vehicle 1 is limited in emergency operating mode.

German patent application no. 1020231 20573.0, filed Aug. 3, 2023, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for operating a load having a first voltage of an electric vehicle, the method comprising:
operating a traction motor of the electric vehicle as a generator that generates the first voltage during travel of the electric vehicle in an emergency operating mode;
providing, by power electronics having the first voltage connected to the traction motor, an operating voltage for the load having the first voltage of the electric vehicle; and
operating the load having the first voltage in an emergency mode with the operating voltage provided by the power electronics.

2. The method according to claim 1, further comprising:
providing, by a battery having a second voltage that is greater than the first voltage, an operating voltage for the traction motor of the electric vehicle;
operating the traction motor as a drive machine during travel in a normal operating mode with the operating voltage provided by the battery having the second voltage; and
switching the traction motor from the normal operating mode to the emergency operating mode if the battery having the second voltage fails during travel.

3. The method according to claim 2, further comprising:
disconnecting the load having the first voltage from the battery having the second voltage; and
connecting the load having the first voltage to the power electronics having the first voltage if the battery having the second voltage fails while traveling.

4. The method according to claim 1, further comprising:
in the emergency operating mode, providing by a battery having the first voltage of the electric vehicle, the operating voltage for the load having the first voltage when the operating voltage provided by the traction motor in the emergency operating mode drops.

5. The method according to claim 1, further comprising:
limiting a driving speed of the electric vehicle in the emergency operating mode.

6. The method according to claim 1, wherein the travel of the electric vehicle includes coasting of the electric vehicle, rolling downhill of the electric vehicle, or the electric vehicle being towed.

7. A drive system for an electric vehicle, comprising:
power electronics having a second voltage that is greater than a first voltage;
a traction motor connected to the power electronics; and
power electronics having the first voltage connected to the traction motor and the power electronics having the second voltage.

8. The drive system according to claim 7, wherein the traction motor is a separately excited synchronous motor.

9. An electric vehicle, comprising:
the drive system according to claim 7,
a battery having the second voltage; and
a load having the first voltage connected to the power electronics having the first voltage.

10. The electric vehicle according to claim 9, wherein the load having the first voltage is a by-wire steering system of the electric vehicle and/or a by-wire brake of the electric vehicle.
